(19) United States
(12) Patent Application Publication
(10) Pub. No.: US 2002/0094866 A1
(43) Pub. Date: Jul. 18, 2002

(54) Sound controller that generates sound responsive to a situation

(76) Inventors: Yasushi Takeda, Tokyo (JP); Noriyuki Henmi, Tokyo (JP); Isamu Terasaka, Tokyo (JP); Yoshikazu Kawatani, Kanagawa (JP)

Correspondence Address: KATTEN MUCHIN ZAVIS ROSENMAN, 575 MADISON AVENUE, NEW YORK, NY, 10022-2585, US

(21) Appl. No.: 10/028,744

(22) Filed: Dec. 20, 2001

(30) Foreign Application Priority Data
Dec. 27, 2000 (JP) 2000-398705
Nov. 15, 2001 (JP) 2001-349837

(51) Int. Cl. A63F 13/00

(52) U.S. Cl. 463/35

(57) ABSTRACT

A sound controller has a volume controller, which adjusts the output level of a sound processor unit, and a CPU, which sets the gains (or ON/OFF condition) of the volume controller responsive to a scene or situation in a video game, thereby enabling generation of sound that is responsive to individual scenes and situations in the video game, and enabling effective audible enactment for a user of various scenes and situations in the video game.

This application is related to Japanese Patent Application No. 2000-398705 filed on Dec. 27, 2000, and No. 2001-349837 filed on Nov. 15, 2001, based on which this application claims priority under the Paris Convention and the contents of which are incorporated herein by reference.

### BACKGROUND OF THE INVENTION

1. Field of the Invention

The present invention relates to a sound controller, a sound control method, a sound control program to be executed on a computer, a computer-readable storage medium having stored therein the sound control program, and a program execution apparatus for executing the sound control program, all of which are preferably applicable to a video game machine or an entertainment system having video game functions.

2. Description of the Related Art

Video game machines, which execute a video game based on a game program stored in a storage medium such as a CD-ROM, DVD-ROM or semiconductor memory are currently in widespread use.

In the video game machine, by operating a controller connected to the main video game machine unit, characters displayed on a display screen are operated, thereby enabling the playing of various video games, such as RPGs (role-playing games), AVGs (adventure games), or SLGs (simulation games)

In many video games, background music as a main theme song of the game is formed, such background music being output from, for example, a speaker unit of a television receiver. It is thus possible to enjoy the operation of characters and the like in a video game while listening to the background music.

In a conventional video game, however, whereas background music should be output while playing the game, the same volume level of background music was output, regardless of the current scene of the game. For this reason, there was the problem of a lack of a dramatic effect in the video game.

For example, although the situation in which a character is outside and that in which the character is inside are different situations, if the same volume level of background music is output in both situations, it is not possible to audibly impart a feeling of tension, reality, and stimulus to the player, thereby preventing effective staging of the drama of each particular scene.

### SUMMARY OF THE INVENTION

Accordingly, it is an object of the present invention, in consideration of the above-noted problems in the conventional art, to provide a sound controller, a sound control method, a sound control program to be executed on a computer, a computer-readable storage medium having stored therein the sound control program, and a program execution apparatus for executing the sound control program, all of which enable generation of sound that effectively portrays the drama of each scene in a video game.

In the present invention, sound source information of each channel is reproduced, based on sequence information that controls the sound source reproducing operation on each channel, and the output level of the reproduced sound source information is adjusted, responsive to at least scene or situation.

It is thus possible to, for example, audibly impart a feeling of tension, reality, and stimulus to the player of the video game, thereby enabling effective staging of the drama of each scene in the video game.

Other and further objects and features of the present invention will become upon understanding of the illustrative embodiments about to be described in connection with the accompanying drawings or will be indicated in the appended claims, and various advantages not refereed to herein will occur to one skilled in the art upon employing of the invention in practice.

### BRIEF DESCRIPTION OF THE DRAWINGS

FIG. 1 is an oblique view showing the outer appearance of an entertainment system that is an embodiment of the present invention:

FIG. 2 is a block diagram showing the entertainment system according to the embodiment of the present invention;

FIG. 3 is a functional block diagram showing the a sound processor unit provided in the entertainment system according to the embodiment of the present invention; and

FIG. 4 is a table illustrating examples of sound volume adjustment operations in the entertainment system according to the embodiment of the present invention.

### DETAILED DESCRIPTION OF THE PREFERRED EMBODIMENTS

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Configuration of an Embodiment of the Present Invention

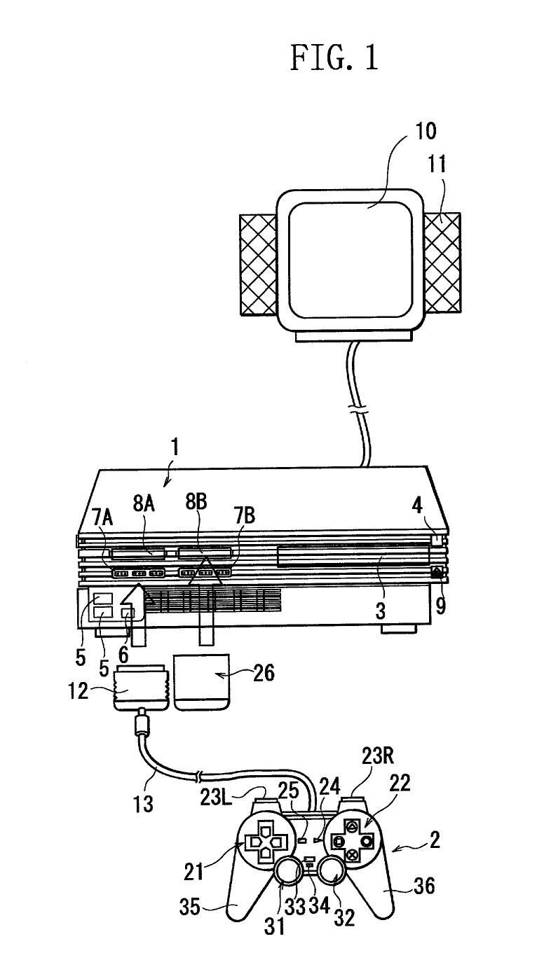

The present invention can be applied to an entertainment system having video game functions as shown in FIG. 1. This entertainment system has a main unit 1 and a controller 2 connected to the main unit 1.

Configuration of the Main Unit

The main unit 1 has a disk tray 3, on which an optical disk such as a CD-ROM or DVD-ROM having stored therein a video game program, sound information such as sound of a character or effective sound, and music information such as a background music (BGM) for the video game is loaded, and a reset button 4 for specifying reset and the like of the operation of the main unit 1.

The main unit 1 has two USB (Universal Serial Bus) connectors 5, an IEEE (Institute of Electrical and Electronics Engineers) 1394 connector 6, controller ports 7A and 7B to which the controllers 2 are connected, memory card slots 8A and 8B into which memory cards 26 for storing game contents up to the point at which playing of a video game was interrupted are inserted, and an eject button 9 for specifying ejection of the optical disk loaded on the disk tray 3.

Although not shown in the drawing, the main unit 1 is provide on its rear panel with a power switch, an audio/video output terminal (AV multi-output terminal), a PC card slot, an optical digital output terminal, and an AC line input terminal or the like. A television receiver 10 used as a monitor is connected to the main unit 1 via the AV multi-output terminal, so that it not only displays a game screen of the video game, but also outputs through a speaker units 11 thereof sounds of a character, effective sound or background music, of the video game.

Controller Configuration

The controller 2 has a left grip 35 gripped and held within the palm of the left hand of the player, a right grip 36 gripped and held within the palm of the right hand of the player, a left operating part 21 and a right operating part 22, which are each operated by the thumbs of the left and right hands, respectively, while the grips 35 and 36 being gripped by the left and right hands of the player, respectively, a left analog operating part 31 and a right analog operating part 32, which have joysticks enabling analog operation (joystick operation) by the left and right thumbs, a first left pushbutton 23L and a first right pushbutton 23R, which are operated by pressing by the left and right index fingers, respectively, and a second left pushbutton and a second right pushbutton (not shown), which are provided below the first left and right pushbuttons 23L and 23R, respectively, and which are operated by the middle fingers of the left and right hands, respectively.

The above-noted left operating part 21 is provided with “up”, “down”, “left” and “right” direction keys, used, for example, when a player moves a character, for example, to up, down, left, and right directions respectively on the screen. The “up”, “down”, “left” and “right” direction keys are used not only to issue “up”, “down”, “left” and “right” direction commands, but can also be used for issuing commands for an oblique direction. For example, if the “up” key and the “right” key are pressed simultaneously, it is possible to issue a command for the upper-right direction. The same is true of the other direction keys. For example, if the “down” direction key and the “left” direction key are pressed simultaneously, a command is given for the lower-left direction.

The right operating part 22 has four command buttons (these buttons being respectively marked by engraved □, Δ, ×, and ∘ marks), to which different functions are assigned by a game application program.

The above-noted joysticks are capable of precession in response to analog operations by the left and right analog operating parts 31 and 32. When they are standing upright (that is, when they are not operated so as to impart an inclination thereto), the position thereof is held in the vertical attitude (reference position) condition in which they are not inclined from the vertical, and when they are operated so as to impart an inclination thereto, coordinate values on an X-Y coordinate are detected based on the amount of inclination with respect to the reference position and the direction of the inclination, such detected coordinate values being supplied to the main unit 1 as the operation output.

The controller 2 is further provided with a mode selection button 33 for switching between the analog operating mode and the digital operating mode, a light indicator 34 for notifying a player, for example by lightning of an LED (light-emitting diode) or the like, of the operating mode selected by the mode selection button 33, a start button 24 for giving commands for starting, pausing or reproducing a game, and a select button 25 for instructing display of a menu or the operating panel on the television receiver 11.

When the mode selection button 33 is used to select the analog operating mode, the light indicator 34 is controlled so as to light, and the left and right analog operating parts 31 and 32 are activated. When the digital operating mode is selected, the light indicator 34 is extinguished and operation of the left and right analog operating parts 31 and 32 are deactivated.

In addition, the controller 2 is provided within the left grip 35 and the right grip 36 with a vibration generating mechanism which generates a vibration, for example by causing a weight that is eccentrically disposed with respect to a motor to rotate, thereby enabling operation of the vibration generating mechanism in response to a command from the main unit 1 when a character being damaged, for example. By doing this, it is possible to impart a vibration to the hands of a player holding the controller 2, thereby making playing the game more fun. When the various buttons and operating parts provided on the controller 2 are operated by the player, the controller 2 generates an operating signal corresponding to the operation, such operating signal being supplied to the main unit 1 via a cable 13 and a controller connecting portion 12.

Electrical Configuration of the Main Unit

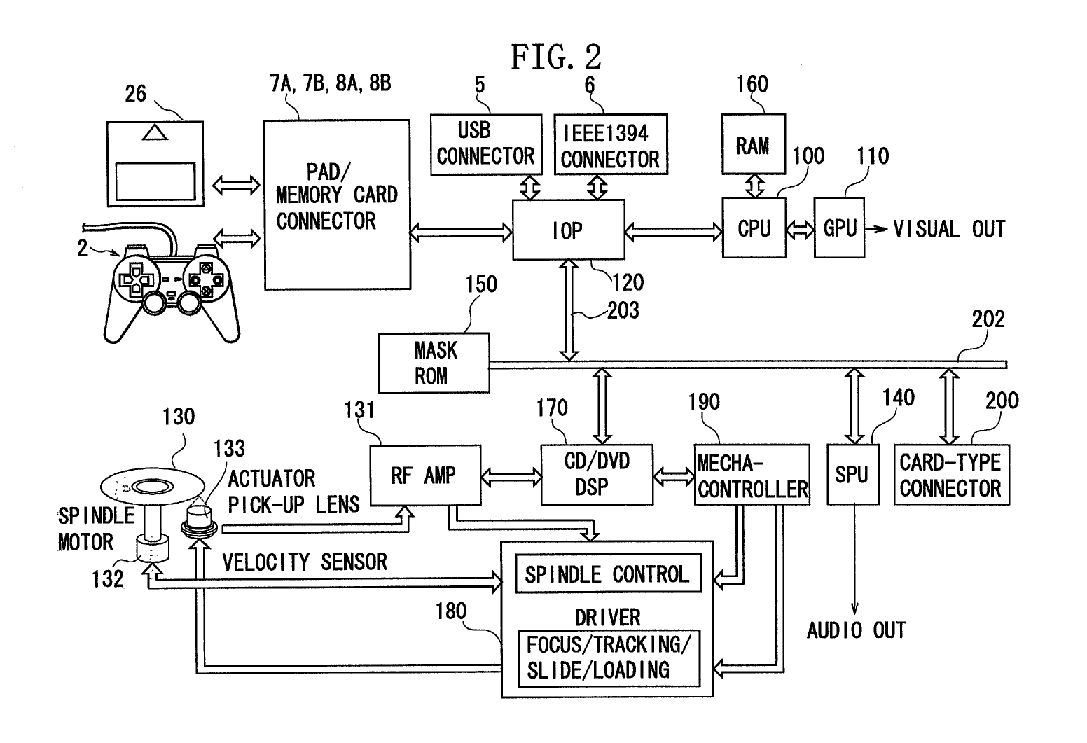

As shown in FIG. 2, the main unit 1 has a main CPU 100 for performing signal processing and control of internal constituent elements, based on various programs such as a game application program, a graphic processing unit (GPU) 110 for performing image processing, an IO processor (IOP) 120 for performing interface processing between the main unit 1 and an external device such as the controller 2 and the memory card 26 or the like, a mechanical controller 190 for performing reproduction control of the optical disk 130 such as a DVD-ROM or. CD-ROM onto which an application program or multi-media data is stored, a main memory (RAM) 160 which includes functions as a working area for the main CPU 100 and a buffer for temporary storing data read out from the optical disk 130, a MASK-ROM 150 into which an operating system program executed by the main CPU 100 or the IOP 120 is mainly stored, and a sound processor unit (SPU) 140 for performing audio signal processing.

The main unit 1 has a CD/DVD digital signal processor 170 (DSP) responsible for error correction processing (CIRC processing) of reproduction output from the optical disk 130 supplied via an RF amplifier 131, and responsible for expanding and decoding processing of compressed coded data; a driver 180 and the mechanical controller 190 for controlling rotation of a spindle motor 132, focus and tracking control of an optical pickup 133, and loading control of the disk tray; and a card-type connector (PC card slot) 200 for connecting, for example, a communication card or an external hard disk drive or the like.

These various elements are mutually connected via bus lines 202 and 203 or the like. The connection between the main CPU 100 and the graphic processor 110 is made by a dedicated bus line, and the connection between the main CPU 100 and the IOP 120 is made by a sub-bus SBUS. The IOP 120 is connected to the CD/DVD digital signal processor 170, the MASK-ROM 150, the sound processor unit (SPU) 140, and the card-type connector 200 by an SBUS.

The main CPU 100, by executing an operating system program for the main CPU stored in the MASK-ROM 150, controls the overall operation of the main unit 1. The main CPU 100, by executing various application programs read out from the optical disk 130 and loaded into the main memory 160, or by executing various application programs downloaded via a communication network, also controls the operation of a video game in the main unit The IOP 120, by executing an operating system program therefor stored in the MASK-ROM 150, performs such tasks as input/output of a signal sent from the controller 2 in response to operation by a player and data sent from the memory card 26 for storing game settings, in addition to control of input/output of data at a USB connector (not shown), at an IEEE 1394 connector, or at a PC card slot or the like, and data protocol conversion.

The MASK-ROM 150 can store device IDs for the controllers 2 connected to the controller ports 7A and 7B, the memory cards 26 connected to the memory card slots 8A and 8B, and PC cards and the like connected to the card-type connector (PC card slot) 200, and the IOP 200 performs communication with devices such as the above-noted controllers 2, the memory cards 26 or the like, in accordance with such device IDs, to thereby specify the external devices such as the controller 2 or the memory card or the like, which are connected to the main unit 1.

The graphic processor unit 110 performs drawing in accordance with drawing instructions from the main CPU 100, and stores drawn images in a frame buffer (not shown). The graphic processor unit 110 also has a function as a geometry transfer engine responsible for processing such as coordinate transfer.

That is, the graphic processor unit 110, in serving as a geometry transfer engine, in the case in which an application program such as a video game stored in the optical disk 130 uses so-called three-dimensional (3D) graphics, constructs virtual three-dimensional objects which are formed by a set of triangular polygons. The graphic processor unit 110 also performs various calculations for generating an image possibly obtained by photographing such three-dimensional object with a virtual camera, that is, the perspective conversion for rendering (calculations of coordinate value for the case in which the vertices of each polygon making up a three-dimensional object are projected onto a virtual screen) The graphic processor unit 110, in accordance with drawing instructions from the main CPU 100, performs rendering of three-dimensional objects to generate an image with respect to the frame buffer while making use, if necessary, of the geometry transfer engine. The graphic processor unit 110 outputs a video signal responsive to such generated images.

The sound processor unit 140 has an ADPCM decoding function for reproducing sound data which were processed by adaptive predictive coding, a reproducing function for reproducing and outputting audio signals such as effective sound or the like by reproducing waveform data stored in a sound buffer built in such unit 140 or externally attached thereto, and a modulation function for modulating and reproducing the waveform data stored in the sound buffer.

The sound processor unit 140 thus provided with such functions can be used as a so-called sampling sound source, which can generate audio signals of music sound and effective sound and the like from the waveform data stored in the sound buffer, based on instructions from the CPU 100.

Overall Video Game Execution

First, when the main power supply of a main unit 1 configured as described above is switched on, an operating system program for the main CPU and an operating system program for the IOP are each read out from the MASK-ROM 150, the main CPU 100 and the IOP 120 executing each corresponding operating system program. By doing this, the main CPU 100 performs overall control of the main unit 1, and the IOP 120 performs input/output signal control between the controller 2 and the memory card 26 or the like.

When the main CPU 100 executes its operating system program, after performing initialization processing such as a verification of operation, it reads out an application program for a game or the like recorded on the optical disk 130 and, after loading the program in the main memory 160, then executes such program.

By execution of the game application program, the main CPU 100 controls the graphic processor unit 110 and the sound processor unit 140, responsive to player's commands input by a controller 2 via the IOP 120, so as to perform control of image display, effective sound, and music (background music)

Sound Control Configuration

Next, the entertainment system according to this embodiment controls the sound processor unit 140 so as to control the generation of effective sound or background music, thereby providing sounds appropriate to each scene of the video game.

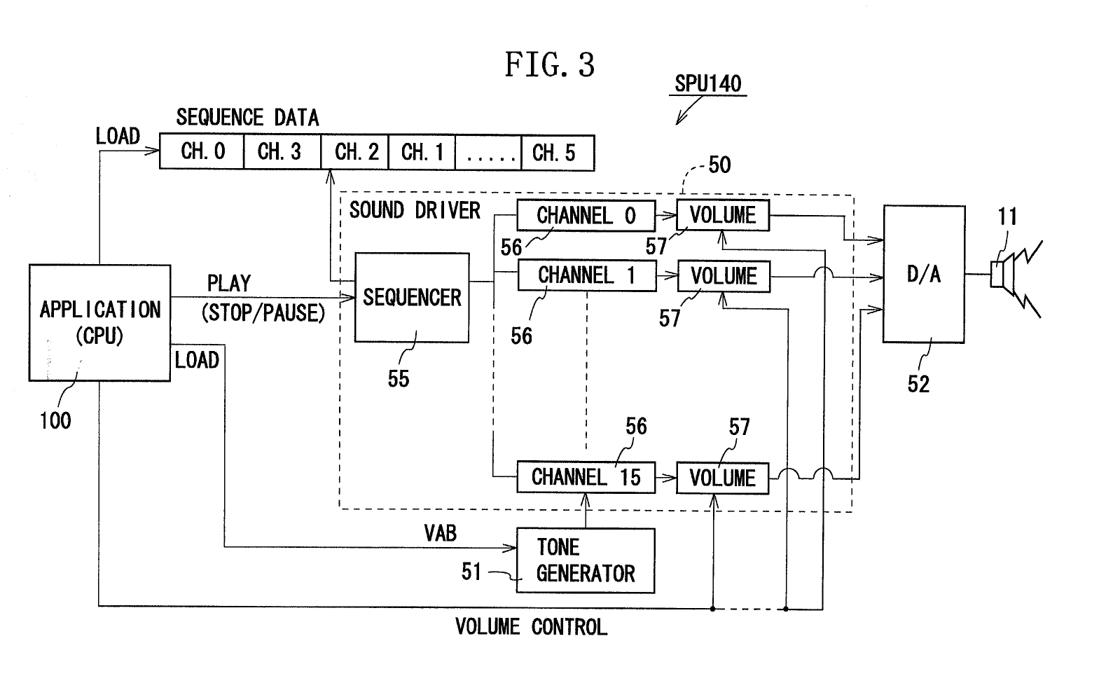

FIG. 3 is a functional block diagram showing the concept of the sound processor unit 140, from which drawing it can be seen that the sound processor unit 140 has a sound driver 50, a tone generator 51, and a D/A converter 52.

The sound driver 50 has a sequencer 55 for controlling sound generation of sound source data, based on sequence data such as MIDI (Musical Instrument Digital Interface) data or the like, a plurality of sound source reproducing channels 56 (Channel 0 to Channel 15 in FIG. 3) for reproducing sound source data (VAB) supplied from the tone generator 51 under control of the sequencer 55, a plurality of volume controllers 57 for performing volume control of the reproduction output of such reproduced sound source data, and a D/A converter 52 for converting the reproduction output of the sound source data from the volume controllers 57 to analog form and supplies same, for example, to a speaker units 11 of a television receiver The sound source data reproduced by each of the sound source reproducing channels 56 is usually output at predetermined volume level for each channel. In an entertainment system according to this embodiment of the present invention, the volume controller 57 is provided between each of the sound source reproducing channels 56 and the D/A converter 52. The CPU 100 controls the gains of the volume controllers 57 to thereby control the sound output from each of the sound source reproducing channels 56 to its predetermined volume level.

In the example shown, the sound processor unit (SPU) 140 is shown as having a total of 16 sound source reproducing channels 56, Channel 0 through Channel 15, and this will be the basis for the description below as well. It will be understood, however, that this is merely one example of the number of channels, and that the number of channels can be arbitrarily established, thus making it possible to have a design having, for example, 48 channels.

Sound Control Operation

First, when the video game is started, the CPU 100 extracts the sequence data and the sound source data (VAB) from the overall game program read from the optical disk 130, supplies the sequence data to the sequencer 55 of the sound driver 50, and supplies the sound source data to the tone generator 51. The tone generator 51 supplies each of the sound source data to the corresponding sound source reproducing channel 56.

In just one example, the sequence data, as shown in FIG. 3, is formed so that the sequence data for the sound source reproducing channels 56 is arranged parallel in time sequence such as Channel 1, Channel 2, Channel 3, Channel 4, Channel 5 . . . , the sequencer 55, in accordance with the sequence data, performing drive control of the specified sound source reproducing channel 56. By doing this, sound source data supplied to the sound source reproducing channels 56 driven by the sequencer 55 is reproduced and supplied to the corresponding volume controllers 57.

In this case, the optical disk 130 has recorded volume control information indicating the volume levels of each of the volume controllers 57 for each scene and situation in a video game. The CPU 100 controls the gains of each of the volume controllers 57 in accordance with the volume control information for each game scene and situation.

By doing this, the reproduction output level of the sound source data supplied to each volume controller 57 is changed appropriately for each scene or situation, converted to analog form by the D/A converter 52, and supplied to the speaker units 11 of the television receiver 10, thereby achieving a sound output at volume that is responsive to each scene or situation in a game.

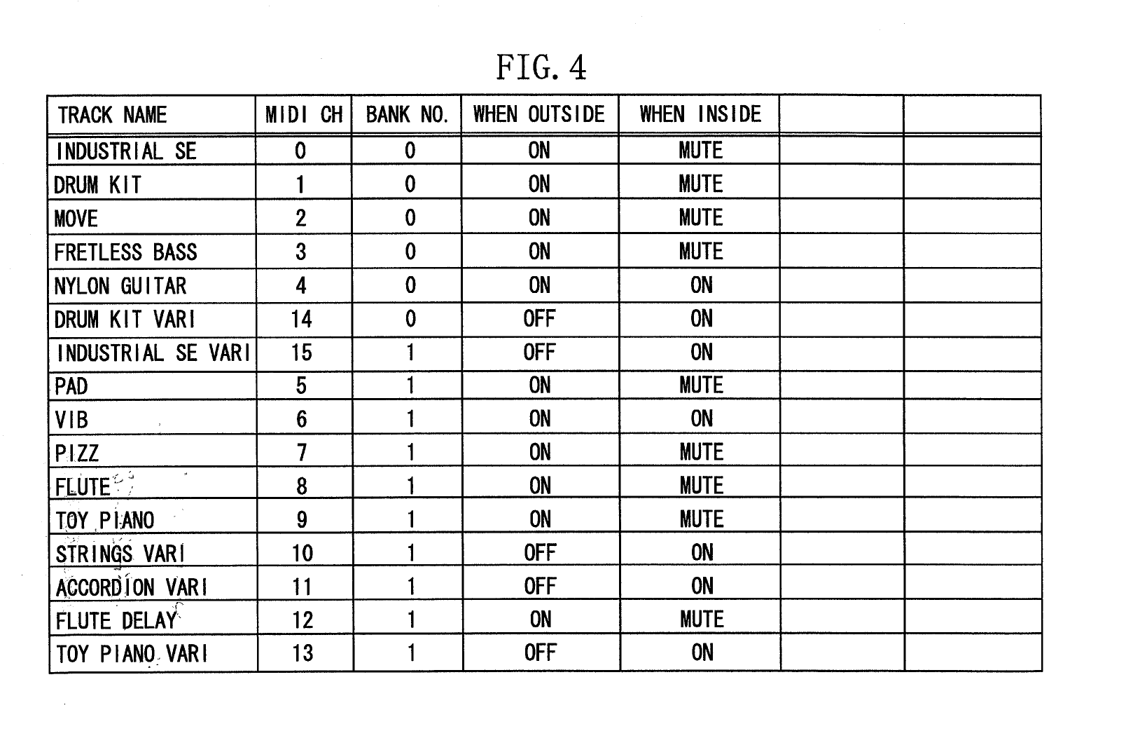

More specifically, FIG. 4 is a table showing the drive conditions for the volume controllers 57 corresponding, for example, to the situation in which a main character of a game is outside and the situation in which the main character is inside.

The channel assignments in the example shown in FIG. 4 are as follows.

The sound source reproducing channel 56 for Channel 0 is “industrial se”;

The sound source reproducing channel 56 for Channel 1 is “Drum Kit”;

The sound source reproducing channel 56 for Channel 2 is “Move”;

The sound source reproducing channel 56 for Channel 3 is “Fretless Bass”;

The sound source reproducing channel 56 for Channel 4 is “Nylon Guitar”;

The sound source reproducing channel 56 for Channel 5 is “pad”;

The sound source reproducing channel 56 for Channel 6 is “Vib”;

The sound source reproducing channel 56 for Channel 7 is “Pizz”;

The sound source reproducing channel 56 for Channel 8 is “Flute”;

The sound source reproducing channel 56 for Channel 9 is “Toy Piano”;

The sound source reproducing channel 56 for Channel 10 is “strings vari”;

The sound source reproducing channel 56 for Channel 11 is “Accordion vari”;

The sound source reproducing channel 56 for Channel 12 is “Flute Delay”;

The sound source reproducing channel 56 for Channel 13 is “Toy Piano vari”;

The sound source reproducing channel 56 for Channel 14 is “Drum Kit vari”;

The sound source reproducing channel 56 for Channel 15 is “Industrial se vari”.

Thus, each of the sound source reproducing channels 56 is assigned a particular part (musical instrument).

The “Bank No.” is 0 for Channel 0 through Channel 4, Channel 14, and Channel 15, and is 1 for Channel 5 through Channel 13.

The sound source reproducing channels 56 for each of the channels are driven based on the above-noted sequence data, and when the CPU 100 detects that the main character is at a location that is outside within a virtual space, the CPU 100 performs drive control so as to switch the volume controllers 57 corresponding to Channel 0 through Channel 9 and Channel 12 each to ON, and so as to switch the volume controllers 57 corresponding to Channel 10, Channel 11, and Channel 13 through Channel 15 to MUTE (OFF), based on the volume control information.

By doing this, the background music formed with the sound source data reproduced by the sound source reproducing channels 56 corresponding to Channel 0 through Channel 9 and Channel 12 is output through the speaker units 11 of the television receiver 10. In this case, because there are a large number of volume controllers 57 that are switched to ON, the background music is output at high volume.

In contrast to the above, if the CPU 100 detects that the main character is at a location that is inside within the virtual space, the CPU 100 performs drive control so as to switch the volume controllers 57 corresponding to Channel 4, Channel 6, Channel 10, Channel 11, and Channel 13 through Channel 15 each to ON, with the volume controllers 57 corresponding to the remaining channels switched to MUTE (OFF), based on the volume control information.

By doing this, because there are a smaller number of volume controllers outputting the sound source data than in the case when the main character is outside, the background music is output at lower volume.

If volume control is performed in this manner, for example whereas in the case in which the main character is outside, not only are crowd noise and other noises output together with the background music output at predetermined volume, when the main character is moved inside, crowd and other noises almost cannot be heard, and the volume of the background music is lowered.

For this reason, it is possible to audibly provide a player with a sense of tension, reality, and stimulus, responsive to individual scenes and situations, thereby enabling an effective enactment of each scene or situation.

Although FIG. 4 shows the case in which the volume controllers 57 corresponding to each channel are controlled in two-ways, that of ON and that of MUTE (OFF), it will be understood that it is further possible to perform step-wise adjustment of the volume level between more steps than merely ON and OFF.

Also, although the foregoing description was for an example in which the sound volume adjustment operation was performed to adapt to two conditions, that in which the main character is outside and that in which the main character is inside, it will be understood that it is also possible in fighting scenes to perform sound volume adjustment responsive to the character's hit points (points of damage to the character).

It is possible, for example, to output background music from a large number of channels when the main character is getting ahead in a fight, but to gradually reduce the number of channels outputting background music when the main character is losing the fight, until finally background music is output from only a single channel. By doing this, it is possible to have the background music for cheering the player, so that the player can enjoy more exciting fight scene.

Another possibility is to set a sound generator to a predetermined object, such as a building or location (for example, a department store or congested town area), and to perform volume adjustment so as to gradually increase the sound volume as a character approaches a building or location and the like (or to apply MUTE to many channels at first and then gradually remove the MUTE condition and change to the ON condition). By doing this, it is possible to gradually increase the sound output as the character approaches a building or location that is the sound generator, thereby enhancing the feeling of reality in the video game.

As is clear from the foregoing description, an entertainment system according to this embodiment of the present invention is provided with volume controllers 57 that adjust the output levels of sound source data reproduced in accordance with sequence data such as MIDI data, the CPU 100 of the entertainment system setting the gains (or setting the ON/OFF condition) of the volume controllers 57 responsive to particular scenes or situations, thereby enabling effective enactment of the various scenes and situations occurring in a video game.

Although the example described is one in which MIDI is used as the sequence data, it will be understood that this is merely one example, and that it is possible to use other forms of sequence data.

Finally, it should be noted that the foregoing is merely an exemplary embodiment of the present invention, and that the present invention is not restricted to this embodiment, it being possible to practice the present invention in various other forms and variations within the scope of the technical concept of the present invention.

What is claimed is:

1. A sound controller, comprising:
means for sound source reproduction, which reproduces sound source information for each channel, in accordance with sequence information controlling a sound source reproducing operation for each channel; and
means for adjusting an output level of the sound source information reproduced by the sound source reproduction means, minimally responsive to a scene or a situation.

2. The sound controller according to claim 1, wherein
the output level adjusting means performs control of output and non-output of the sound source information reproduced by the sound source reproduction means, minimally responsive to a scene or a situation.

3. The sound controller according to claim 1, wherein
the sequence information comprises MIDI (Musical Instrument Digital Interface) information.

4. A method for controlling sound, comprising steps of:
reproducing sound source information for each channel, in accordance with sequence information controlling a sound source reproducing operation for each channel; and
adjusting an output level of the reproduced sound source information, minimally responsive to a scene or a situation.

5. The method for controlling sound according to claim 4, further comprising a step of:
controlling output and non-output of the reproduced sound source information, minimally responsive to a scene or a situation.

6. The method for controlling sound according to claim 4, further comprising a step of:
reproducing the sound source information of each channel, in accordance with MIDI information acting as the sequence information.

7. A program execution apparatus for executing a sound control program, the sound control program comprising:
a step of reproducing sound source information for each channel, in accordance with sequence information controlling a sound source reproducing operation for each channel; and
a step of adjusting an output level of the reproduced source information, minimally responsive to a scene or a situation.

8. The program execution apparatus for executing a sound control program according to claim 7, the sound control program comprising:
a step of controlling output and non-output of the reproduced sound source information, minimally responsive to a scene or a situation.

9. The program execution apparatus for executing a sound control program according to claim 7, the sound control program comprising:
a step of reproducing the sound source information for each channel, in accordance with MIDI information acting as the sequence information.

10. A computer-readable storage medium having recorded therein a sound control program to be executed on a computer, the sound control program comprising:
a step of reproducing sound source information for each channel, in accordance with sequence information controlling a sound source reproducing operation for each channel; and
a step of adjusting an output level of the reproduced source information, minimally responsive to a scene or a situation.

11. The computer-readable storage medium having recorded therein a sound control program to be executed on a computer according to claim 10, the sound control program comprising:
a step of controlling output and non-output of the reproduced sound source information, minimally responsive to a scene or a situation.

12. The computer-readable storage medium having recorded therein a sound control program to be executed on a computer according to claim 10, the sound control program comprising:
a step of reproducing the sound source information for each channel, in accordance with MIDI information acting as the sequence information.

13. A sound control program to be executed on by a computer, comprising:
a step of reproducing sound source information for each channel, in accordance with sequence information controlling a sound source reproducing operation for each channel; and
a step of adjusting an output level of the reproduced source information, minimally responsive to a scene or a situation.

14. A sound controller, comprising:
a sound source reproduction unit, that reproduces sound source information for each channel, in accordance with sequence information controlling a sound source reproducing operation for each channel; and
an output level adjusting unit, which adjusts a output level of the sound source information reproduced by the sound source reproduction unit, minimally responsive to a scene or a situation.
